(19) United States
(12) Patent Application Publication
(10) Pub. No.: US 2022/0400194 A1
(43) Pub. Date: Dec. 15, 2022

(54) LENS MOUNT AND LENS APPARATUS HAVING THE SAME

(71) Applicant: CANON KABUSHIKI KAISHA, Tokyo (JP)

(72) Inventors: Hiroki Ito, Kanagawa (JP); Taro Murakami, Tokyo (JP); Atsuto Noda, Tokyo (JP); Takumi Uehara, Kanagawa (JP)

(21) Appl. No.: 17/836,903

(22) Filed: Jun. 9, 2022

(30) Foreign Application Priority Data
Jun. 11, 2021 (JP) 2021-097794

(51) Int. Cl. H04N 5/225; G02B 7/02; G03B 17/02

(52) U.S. Cl. CPC H04N 5/2254; G02B 7/022; G03B 17/02

(57) ABSTRACT

A lens mount includes a cover member and a holder. The cover member has a first opening corresponding to a first optical system of a lens apparatus and has a second opening corresponding to a second optical system of the lens apparatus. The holder holds a filter to cover the first opening and the second opening. The holder includes a first holder disposed on one side with respect to the first and second openings in a direction orthogonal to an arrangement direction of the first and second openings, and a second holder disposed on the other side with respect to the first and second openings in the direction orthogonal to the arrangement direction. A groove portion is formed between the cover member and the holder, and the filter is insertable into the groove portion.

### BACKGROUND

### Field of the Disclosure

The disclosure relates to a lens mount and a lens apparatus having the same.

### Description of the Related Art

An interchangeable lens for stereoscopic photography (imaging) has conventionally been known as an application of one of interchangeable lens systems. Japanese Patent Laid-Open No. 2012-3022 discloses a lens that includes two optical systems arranged in parallel and images two image circles in parallel on a single image sensor.

A configuration for attaching a filter to a surface closest to an image plane of the interchangeable lens is known. Japanese Utility-Model Laid-Open No. 57-130808 discloses a configuration for holding a filter using a U-shaped or semicircular member around an opening on a mounted side of an interchangeable lens.

In viewing with a VR goggle, it is desirable that an angle of view of a moving (motion) or still image is 180 degrees or higher in order to obtain not only a three-dimensional effect but also a realistic effect. In order to provide an image with an angle of view of at least 180 degrees in consideration of manufacturing errors and the like, it is desirable that an imaging lens can capture an image at an angle of view higher than 180 degrees.

However, the lens disclosed in Japanese Patent Laid-Open No. 2012-3022 cannot capture the image at the angle of view higher than 180 degrees. In order to capture the image at the angle of view higher than 180 degrees, it is necessary to place an exterior member on an imaging plane side of a vertex of a front lens so that the exterior member does not shield a light beam of 180 degrees or higher incident on the front lens and to provide openings in the exterior member into which the two lenses can be inserted. In this case, when the positions of the lenses shift, gaps between the opening and the lens become non-uniform, which may deteriorate appearance quality. Moreover, in the case where a drip-proof structure is provided, the non-uniformity of the gaps adversely affects the dust-proof and drip-proof performance If the opening and the lens are diameter-engaged with each other so that the gaps do not become non-uniform, the position offset of the lens is corrected, which will adversely affect the optical performance and relative relationship between the two optical systems.

Since two openings are provided in parallel in the interchangeable lens for stereoscopic imaging, the angle of view is shielded if the configuration disclosed in Japanese Utility-Model Laid-Open No. 57-130808 is used. Moreover, in the case where the configuration disclosed in Japanese Utility-Model Laid-Open No. 57-130808 is manufactured as a single component, molding becomes difficult because each opening is long, and it is difficult to attach or detach the filter because the filter to be attached is elongated.

### SUMMARY OF THE DISCLOSURE

The disclosure provides a lens mount and a lens apparatus having the same, each of which can have a simple structure and facilitate attachment and detachment of a filter.

According to an aspect of the present disclosure, a lens mount configured to attach and detach a lens apparatus to and from an image pickup apparatus, wherein the lens apparatus includes a first optical system and a second optical system, the lens mount includes a cover member having a first opening corresponding to the first optical system and a second opening corresponding to the second optical system, and a holder configured to hold at least one filter configured to cover the first opening and the second opening, wherein the holder includes a first holder disposed on one side with respect to the first and second openings in a direction orthogonal to an arrangement direction of the first and second openings, and a second holder disposed on the other side with respect to the first and second openings in the direction orthogonal to the arrangement direction, and wherein a groove portion is formed between the cover member and the holder, and the at least one filter is insertable into the groove portion.

Further features of the disclosure will become apparent from the following description of exemplary embodiments with reference to the attached drawings.

### BRIEF DESCRIPTION OF THE DRAWINGS

FIG. 1 is a schematic configuration diagram of a camera system according to one embodiment of the disclosure.

FIG. 2 is a sectional view of a lens apparatus.

FIG. 3 is an exploded perspective view of the lens apparatus viewed from an object side.

FIG. 4 is an exploded perspective view of the lens apparatus viewed from an imaging plane side.

FIG. 5 is a front view of the lens apparatus.

FIG. 6 is a sectional view taken along a line A-A in FIG. 5.

FIG. 7 illustrates a variation of the lens apparatus.

FIG. 8 is a sectional view taken along a line B-B of FIG. 5.

FIG. 9 illustrates a positional relationship between each optical axis and an image circle on an image sensor.

FIG. 10 illustrates reflection (glare or ghost) of a left-eye optical system in a case where an image is captured by a right-eye optical system.

FIG. 11 is a rear view of a mount cover.

FIG. 12 illustrates an image circle to be imaged by a circumferential fisheye lens.

FIG. 13 is a sectional view of the mount cover.

FIG. 14 is a perspective view of the mount cover.

FIG. 15 is a rear view of the mount cover while a filter holder is detached.

FIG. 16 is a perspective view of the mount cover while a filter is attached.

FIG. 17 is a sectional view of the mount cover while the filter is attached.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

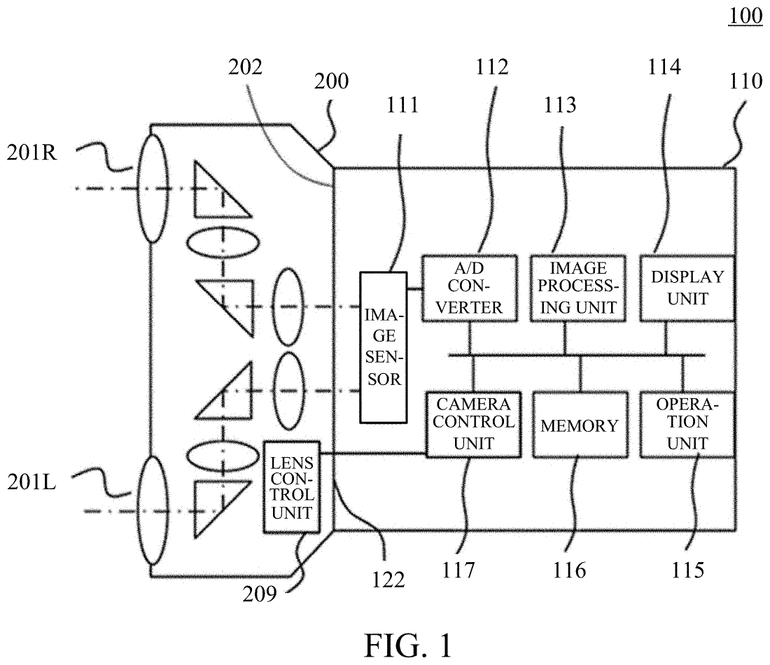

FIG. 1 is a schematic configuration diagram of a camera system 100 according to one embodiment of the disclosure. The camera system 100 includes a camera body (image pickup apparatus) 110 and a lens apparatus (interchangeable lens) 200, and can capture a stereoscopic image.

The camera body 110 includes an image sensor 111, an A/D converter 112, an image processing unit 113, a display unit 114, an operation unit 115, a memory 116, a camera control unit 117, and a camera mount 122.

The lens apparatus 200 includes a right-eye optical system (first optical system) 201R, a left-eye optical system (second optical system) 201L, a lens mount (mount unit) 202, and a lens control unit 209, and is attachable to and detachable from the camera body 110. These two optical systems are arranged in parallel (symmetrically) and configured such that two image circles are imaged in parallel on the image sensor 111. These two optical systems are arranged horizontally and spaced by a predetermined distance (baseline length). When viewed from the imaging plane side (image side), a right image captured by the right-eye optical system 201R is recorded as a moving or still image for the right eye, and a left image captured by the left-left-eye optical system 201L is recorded as a moving or still image for the left eye. The reproduced moving or still images are viewed with a 3D display, VR goggles, or the like, so that the right-eye image is displayed on the right eye of the viewer and the left-eye image is displayed on the left eye of the viewer. At this time, images having a parallax are projected on the right and left eyes depending on the baseline length and provide the viewer with a stereoscopic effect. Thus, the lens apparatus 200 is a lens apparatus for stereoscopic imaging that can capture two images having a parallax using two optical systems.

When the lens apparatus 200 is attached to the camera body 110 via the lens mount 202 and the camera mount 122, the camera control unit 117 and the lens control unit 209 are electrically connected to each other.

The object images including the right-eye image formed via the right-eye optical system 201R and the left-eye image formed via the left-eye optical system 201L are formed on the image sensor 111 in parallel. The image sensor 111 converts the captured object images (optical signals) into analog electric signals. The A/D converter 112 converts the analog electric signals output from the image sensor 111 into digital electric signals (image signals). The image processing unit 113 performs various image processing for the digital electric signals output from the A/D converter 112.

The display unit 114 displays various information. The display unit 114 includes, for example, an electronic viewfinder or a liquid crystal panel. The operation unit 115 has a function as a user interface for the user to give an instruction to the camera system 100. In the case where the display unit 114 has a touch panel, the touch panel also constitutes the operation unit 115.

The memory 116 includes, for example, a ROM, a RAM, and an HDD, and stores various data and programs such as image data that has been processed by the image processing unit 113.

The camera control unit 117 includes, for example, a CPU, and integrally controls the entire camera system 100.

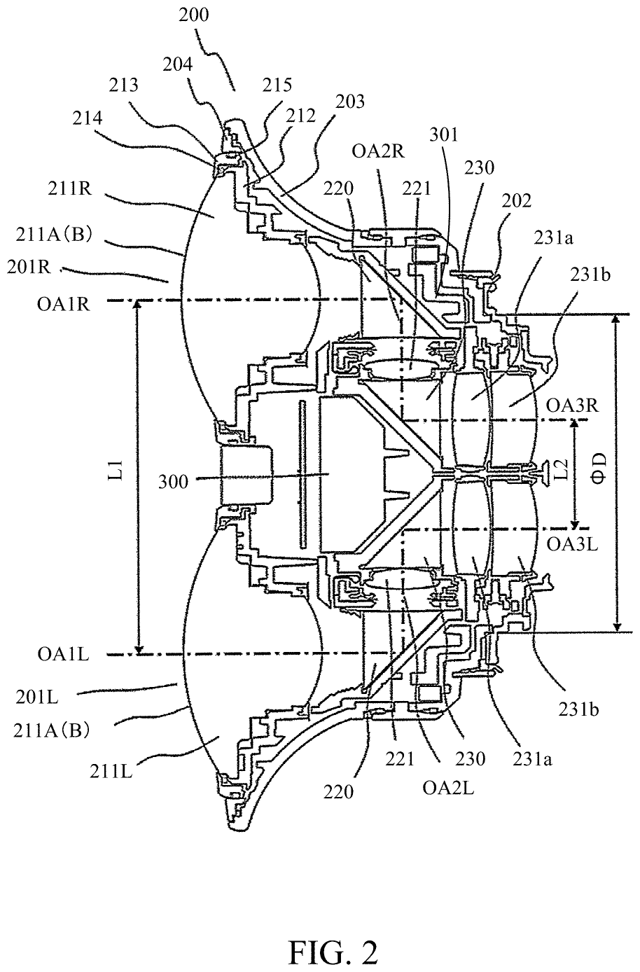

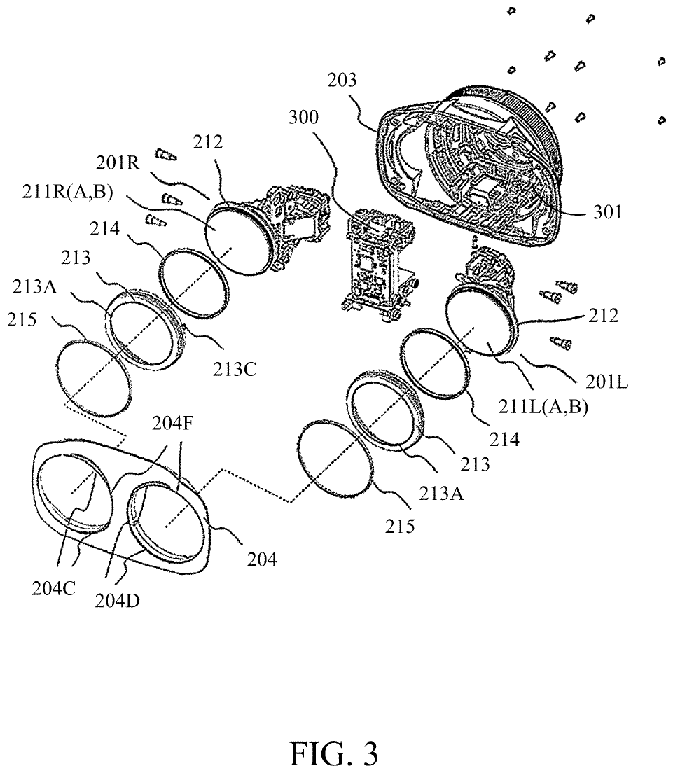

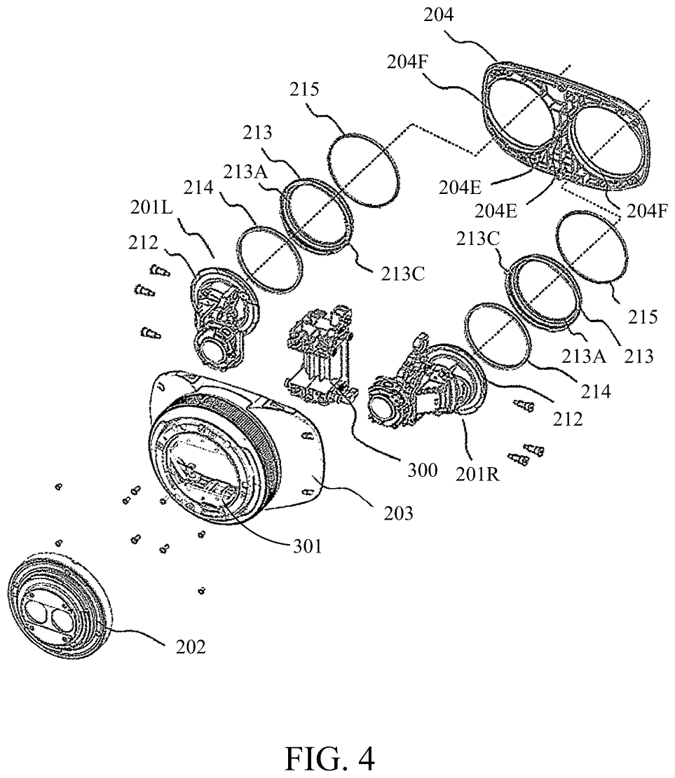

FIG. 2 is a sectional view of the lens apparatus 200. FIG. 3 is an exploded perspective view of the lens apparatus 200 viewed from the object side. FIG. 4 is an exploded perspective view of the lens apparatus 200 viewed from the imaging plane side.

In the following description, a description of the right-eye optical system 201R will be given R at the end of the reference numeral, and a description of the left-eye optical system 201L will be given L at the end of the reference numeral. In the description common to both the right-eye optical system 201R and the left-eye optical system 201L, neither R nor L will be added to the end of the reference numeral. Each of the right-eye optical system 201R and the left-eye optical system 201L can capture an image at an angle of view higher than 180 degrees. Each optical system is a bending optical system having two reflective surfaces. In each optical system, a first optical axis OA1, a second optical axis OA2 approximately orthogonal to the first optical axis OA1, and a third optical axis OA3 parallel to the first optical axis OA1 are set in this order from the object side. Each optical system includes a first lens 211 having a convex lens surface 211A on the object side disposed on the first optical axis OA1, a second lens 221 disposed on the second optical axis OA2, and third lenses 231a and 231b disposed on the third optical axis OA3. Each optical system has a first prism 220 that bends a light beam on the first optical axis OA1 and guides it to the second optical axis OA2, and a second prism 230 that bends the light beam on the second optical axis OA2 and guides it to the third optical axis OA3. In the following description, the optical axis direction indicates a direction parallel to the first optical axis OA1, which is a direction extending toward the object side and the imaging plane side.

Each optical system is fixed to a lens top base 300 by tightening screws or the like. The lens top base 300 is fixed to the lens bottom base 301 by tightening screws or the like. The lens bottom base 301 is held movably in the optical axis direction while it is restricted from moving in a rotation direction by an unillustrated linear movement structure. Thereby, since each optical system is integrally movable in the optical axis direction, the right-eye optical system 201R and the left-eye optical system 201L can adjust their focus positions at the same time.

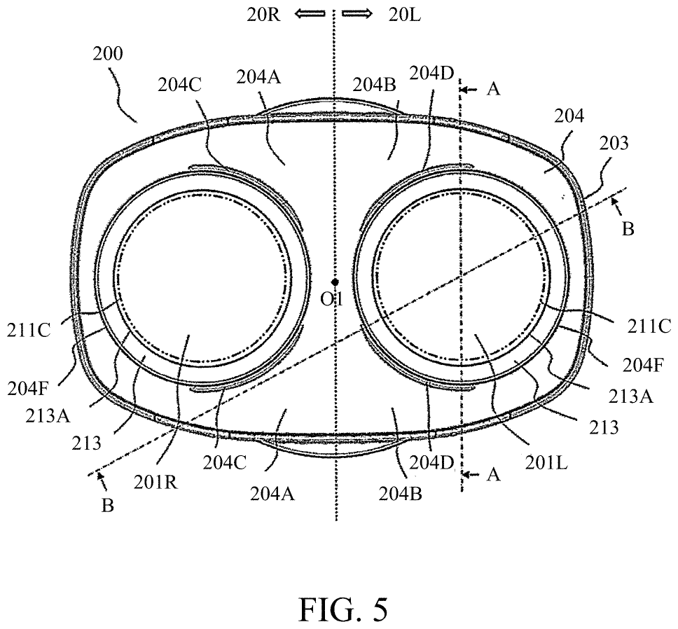

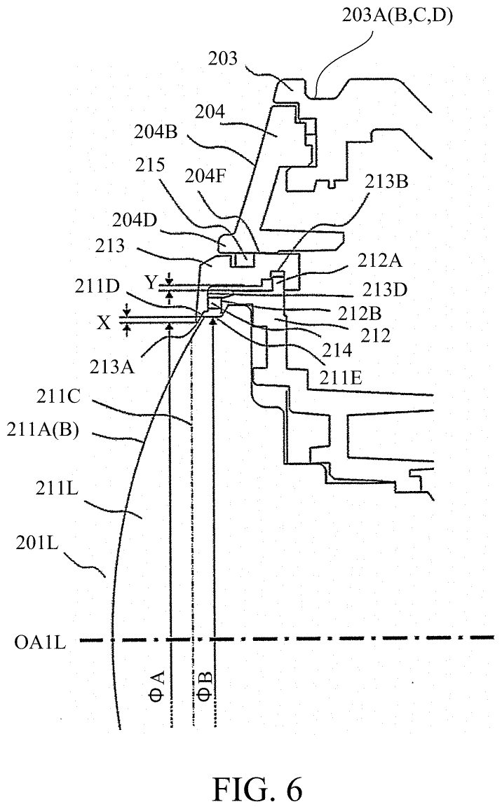

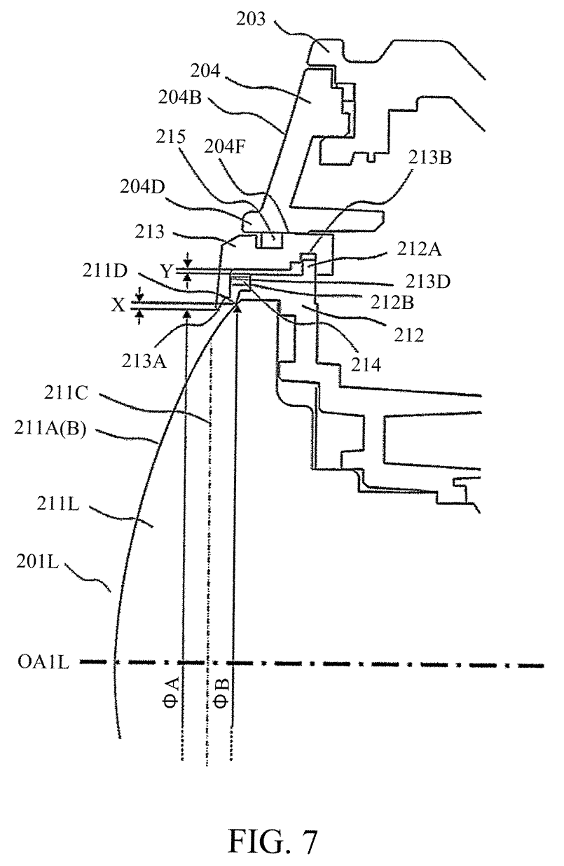

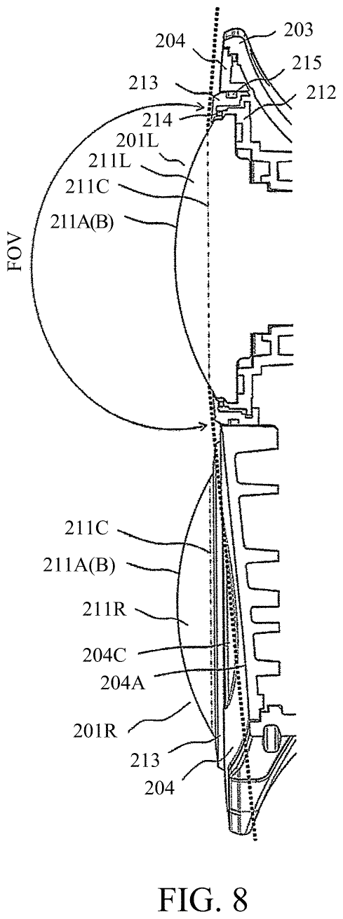

FIG. 5 is a front view of the lens apparatus 200. FIG. 6 is a sectional view taken along a line A-A in FIG. 5, illustrating the structure of the first lens 211 and its periphery. FIG. 7 illustrates a variation of the lens apparatus 200. FIG. 8 is a sectional view taken along a line B-B in FIG. 5, illustrating the structure of the first lens 211 of the lens apparatus 200 and its periphery.

The lens apparatus 200 includes an exterior cover member 203 and a front-surface exterior member (exterior member) 204. The exterior cover member 203 houses the right-eye optical system 201R and the left-eye optical system 201L. The front-surface exterior member 204 is screwed and fixed to the exterior cover member 203, and the front-surface exterior member 204 and the exterior cover member 203 can house the front side of the lens apparatus 200 so as to cover it.

The front-surface exterior member 204 has openings (second openings) 204F into which the first lens (first lens) 211R of the right-eye optical system 201R and the first lens (second lens) 211L of the left-eye optical system 201L are inserted. The front-surface exterior member 204 has a shape that does not shield effective light beams of the right-eye optical system 201R and the left-eye optical system 201L each having an effective angle of view FOV higher than 180 degrees. Lens surfaces 211A on the object side of the first lenses 211R and 211L are incident surfaces of the effective light beams on the object side. When an effective incident surface 211B is set to the inside of an effective-incident-surface outer-diameter 211C of the lens surface 211A, a light beam having an angle of view of 180 degrees extends horizontally in a direction approximately orthogonal to the optical axis from the effective incident surface 211B. A light beam having an angle of view higher than 180 degrees is located on the imaging plane side of the effective incident surface 211B, and extends toward the imaging plane side as a position becomes farther from the first lens 211. Therefore, the front-surface exterior member 204 and the cover member 213 are disposed on the imaging plane side of the effective incident surface 211B because they do not shield the light beam having the angle of view higher than 180 degrees.

Now, as illustrated in FIG. 5, assume that a right-eye area 20R is an area located on the right-eye optical system 201R side and a left-eye area 20L is an area located on the left-eye optical system 201L side with respect to a center point O between the right-eye optical system 201R and the left-eye optical system 201L. Then, the front-surface exterior member 204 has an object-side surface 204A in the right-eye area 20R, which approaches the imaging plane as a position is separated from the first lens 211L of the left-eye optical system 201L so as not to shield the outermost effective light beam (thick dotted line portion in FIG. 8) of the left-eye optical system 201L. The front-surface exterior member 204 has an object-side surface 204B in the left-eye area 20L, which approaches the imaging plane as a position is separated from the first lens 211R of the right-eye optical system 201R so as not to shield the outermost effective light beam of the right-eye optical system 201R. However, the first lens 211L and its periphery viewed from the right-eye optical system 201R and the first lens 211R and its periphery viewed from the left-eye optical system 201L also have areas that shield part of mutual effective light beams.

The front-surface exterior member 204 has wall portions 204C and 204D protruding toward the object side from the object-side surfaces 204A and 204B in order to form the openings 204E The wall portion 204C has an arc shape approximately coaxial with the first lens 211R of the right-eye optical system 201R and does not shield the effective light beam of the right-eye optical system 201R, but shields part of the effective light beam of the left-eye optical system 201L. The wall portion 204D has an arc shape approximately coaxial with the first lens 211L of the left-eye optical system 201L and does not shield the effective light beam of the left-eye optical system 201L, but shields part of the effective light beam of the right-eye optical system 201R.

As illustrated in FIG. 6, the lens apparatus 200 includes a first lens holder 212 and a cover member 213. The first lens holder 212 holds the first lenses 211R and 211L. The cover member 213 covers the outer circumference portion of the lens surfaces 211A on the object side of the first lenses 211R and 211L, and has openings (first openings) 213A into which the first lenses 211R and 211L are inserted. The openings 213A are formed so as to expose the first lenses 211R and 211L when viewed from the optical axis direction.

There is a boundary 211D with the lens surface 211A on the outer circumference side of the effective-incident-surface outer-diameter 211C of the first lens 211. The boundary 211D is a boundary between the lens surface 211A and other surfaces or members. For example, the boundary 211D may be a boundary between the lens surface 211A and a side surface 211E of the first lens 211, or as illustrated in FIG. 7, a boundary between the lens surface 211A and an inner diameter tip portion having a caulking claw shape for caulking the first lenses 211R and 211L.

The cover member 213 covers the boundary 211D. That is, the inner diameter of the opening 213A of the cover member 213 is smaller than the diameter of the boundary 211D. Where ΦA is the inner diameter of the opening 213A and ΦB is the diameter of the boundary 211D, an overlap amount X on one side is expressed by the following expression (1).

X=(ΦB−ΦA)/2 (1)

The appearance quality can be improved by covering the boundary 211D.

A groove portion 213B is formed in part of the inner circumference of the cover member 213. A convex portion 212A extending toward the outer circumference side is formed on part of the outer circumference of the first lens holder 212. The groove portion 213B and the convex portion 212A are assembled when they are located at positions where they do not overlap each other when viewed from the optical axis direction, and the convex portion 212A is inserted into the groove portion 213B by rotating the cover member 213. Thereby, the cover member 213 is positioned with the first lens holder 212 in the optical axis direction. The first lens holder 212 may be provided with a groove portion, and the cover member 213 may be provided with a convex portion.

A predetermined gap (first gap) Y is formed in a (diameter) direction orthogonal to the optical axis direction between the first lens holder 212 and the cover member 213. Since the predetermined gap Y is smaller than the overlap amount X of the cover member 213, the cover member 213 can cover the boundary 211D even in a case where the first lens holder 212 or the cover member 213 moves by the predetermined gap Y.

The cover member 213 is positioned with the first lens holder 212 in the optical axis direction and thus is integrally movable with the first lens holder 212 in the optical axis direction. The outer diameter of the cover member 213 is engaged with the inner diameter of the opening 204F of the front-surface exterior member 204. The gap (second gap) in the direction orthogonal to the optical axis direction formed between the front-surface exterior member 204 and the cover member 213 by this engagement is very small and smaller than the predetermined gap Y.

The cover member 213 includes a rotation restricting key (projection) 213C, and the front-surface exterior member 204 includes a rotation restricting groove (groove portion) 204E corresponding to the rotation restricting key 213C. Thereby, when the front-surface exterior member 204 is incorporated, the rotation restricting key 213C is inserted into the rotation restricting groove 204E, and the cover member 213 is restricted from rotating. This structure can prevent the cover member 213 from rotating and coming off from the first lens holder 212. The cover member 213 may be provided with the rotation restricting groove, and the front-surface exterior member 204 may be provided with the rotation restricting key. That is, one of the cover member 213 and the front-surface exterior member 204 may include the rotation restricting key and the other may include the rotation restricting groove.

An optical-axis-direction (OAD) sealing member 214 is a drip-proof and dust-proof member, is disposed between a surface (first surface) 213D on the imaging plane side of the cover member 213 and a surface (second surface) 212B on the object side facing the surface 213D of the first lens holder 212, and seals a space between the surfaces 213D and 212B. The surfaces 213D and 212B may be formed on the entire circumference but may be partially formed. Since the OAD sealing member 214 is sandwiched in the optical axis direction, the cover member 213 and the first lens holder 212 are biased in the optical axis direction, and unsteadiness (or backlash) in the optical axis direction can be reduced.

In order to maintain the predetermined gap Y, the OAD sealing member 214 is disposed with a clearance (gap) larger than the predetermined gap Y with the cover member 213 and the first lens holder 212 in the direction orthogonal to the optical axis direction. The OAD sealing member 214 is made of an elastically deformable material, such as rubber or sponge, and can absorb the predetermined gap Y.

A radial seal member 215 is a drip-proof and dust-proof member and is disposed while sandwiched between the cover member 213 and the opening 204F in the direction orthogonal to the optical axis direction. The radial seal member 215 on the right-eye optical system 201R side is disposed at a position that shields the effective light beam of the left-eye optical system 201L, and the radial seal member 215 on the left-eye optical system 201L side is disposed at a position that shields the effective light beam of the right-eye optical system 201R.

The above-described structure can provide the lens apparatus 200 that can achieve both the dust-proof and drip-proof performance and the optical performance maintain the appearance quality, and enable stereoscopic imaging at an angle of view higher than 180 degrees. Since the first lens holder 212 is not directly engaged with the opening 204F in the front-surface exterior member 204, even if the position of the first lens holder 212 is shifted by the influence of manufacturing errors or the like, the position needs no calibration. Therefore, the optical performance and the relative error between the right-eye optical system 201R and the left-eye optical system 201L do not change even if the front-surface exterior member 204 is incorporated.

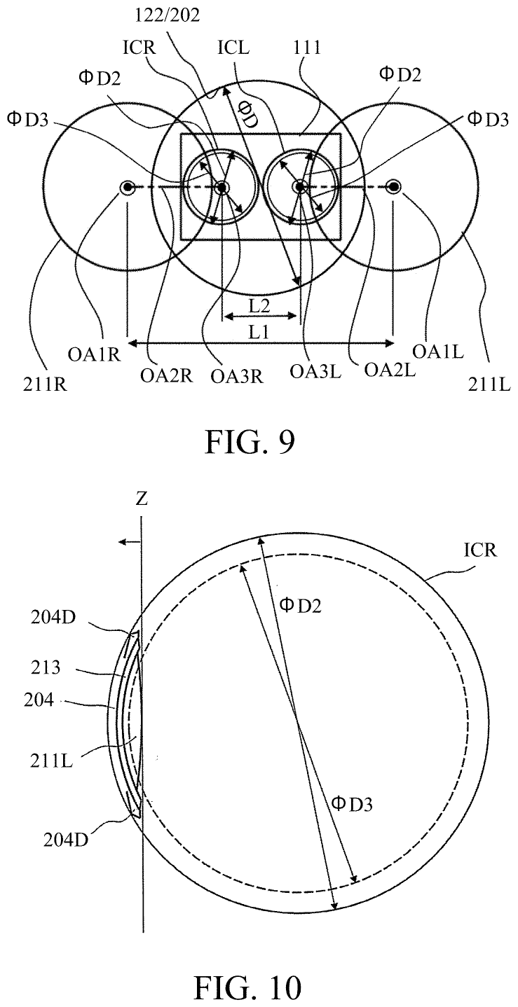

FIG. 9 illustrates a positional relationship between each optical axis of the lens apparatus 200 and the image circles on the image sensor 111.

A right-eye image circle ICR with an effective angle of view formed by the right-eye optical system 201R and a left-eye image circle ICL with an effective angle of view formed by the left-eye optical system 201L are imaged in parallel on the image sensor 111. A diameter ΦD2 of the image circle and a spaced distance between the image circles may be set so that the image circles do not overlap each other. For example, the center of the right-eye image circle ICR may be set to an approximate center of a right area that is made by dividing a light-receiving range of the image sensor 111 into left and right halves at the center, and the center of the left-eye image circle ICL may be set to an approximate center of the left area.

Each optical system is a wide-angle fisheye lens. In this embodiment, each optical system is a circumferential (all-around) fisheye lens, and the image formed on the imaging surface is a circular image reflecting a range of an angle of view higher than 180 degrees, and two circular images are formed on the left and right sides as illustrated in FIG. 9. The longer the distance (baseline length) L1 between the first optical axis OAIR of the right-eye optical system 201R and the first optical axis OA1L of the left-eye optical system 201L is, the more significant the stereoscopic effect becomes during viewing. For example, assume that the image sensor 111 has a size of 24 mm in length×36 mm in width, the diameter ΦD2 of the image circle is 17 mm, a distance L2 between the third optical axes OA3R and OA3L is 18 mm, and the length of the second optical axis is 21 mm. When each optical system is arranged so that the second optical axis extends in the horizontal direction, the baseline length L1 becomes 60 mm, which is almost equal to the eye width of an adult. The lenses disposed on the third optical axis can be placed inside the lens mount 202 by making the diameter ΦD of the lens mount 202 shorter than the baseline length L1, and the distance L2 between the third optical axes shorter than the diameter ΦD of the lens mount 202. In VR viewing, it is said that an angle of view to obtain the stereoscopic effect is about 120 degrees, but a sense of discomfort remains when the field of view is 120 degrees and thus the angle of view is often widened to 180 degrees. Since the effective angle of view exceeds 180 degrees in this embodiment, the diameter ΦD2 of the image circle in this embodiment is larger than the diameter ΦD3 of the image circle in the range of the angle of view of 180 degrees.

FIG. 10 illustrates the reflection (glare or ghost) of the left-eye optical system 201L when the image is captured with the right-eye optical system 201R. The wall portion 204D of the front-surface exterior member 204 is imaged inside the diameter ΦD2 of the image circle, which is the effective angle of view, but is not imaged at an angle of view of 180 degrees, and is imaged outside the diameter ΦD3 of the image circle in the range of the angle of view of 180 degrees. Therefore, VR viewing is not affected in the range of the angle of view of 180 degrees. For example, within the effective angle of view of the right-eye optical system 201R, there are the first lens 211L of the left-eye optical system 201L in the left-eye area 20L, the cover member 213, and the wall portion 204D of the front-surface exterior member 204, which are imaged in the actual effective imaging range as illustrated in FIG. 10. Only the first lens 211L is imaged within the image circle at the angle of view of 180 degrees (inside the diameter ΦD3), but the cover member 213 and the wall portion 204D are located outside the image circle at the angle of view of 180 degrees. The reflection of the wall portion 204D is imaged outside (on the left side illustrated in FIG. 10) even when viewed in the horizontal direction from the vertex portion of the first lens 211L. In the case of image processing or image editing, if the outside of the vertex portion indicated by a straight line Z of the first lens 211L is cut, which is always reflected due to the specifications, the reflection of the wall portion 204D will not be affected. This is similarly applied to the reflection of the right-eye optical system 201R when an image is captured with the left-eye optical system 201L. As described above, although the wall portion 204D is located within the effective angle of view, it is located so as to have almost no influence on imaging in the actual VR application.

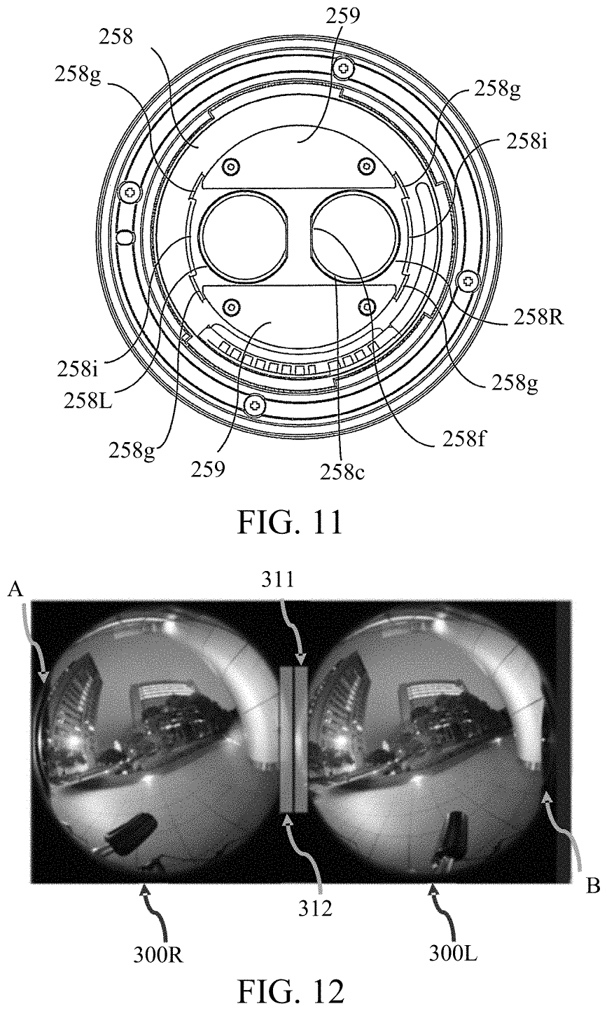

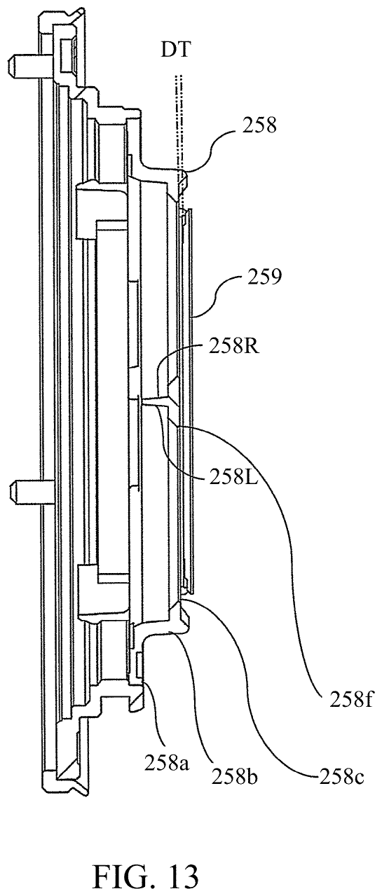

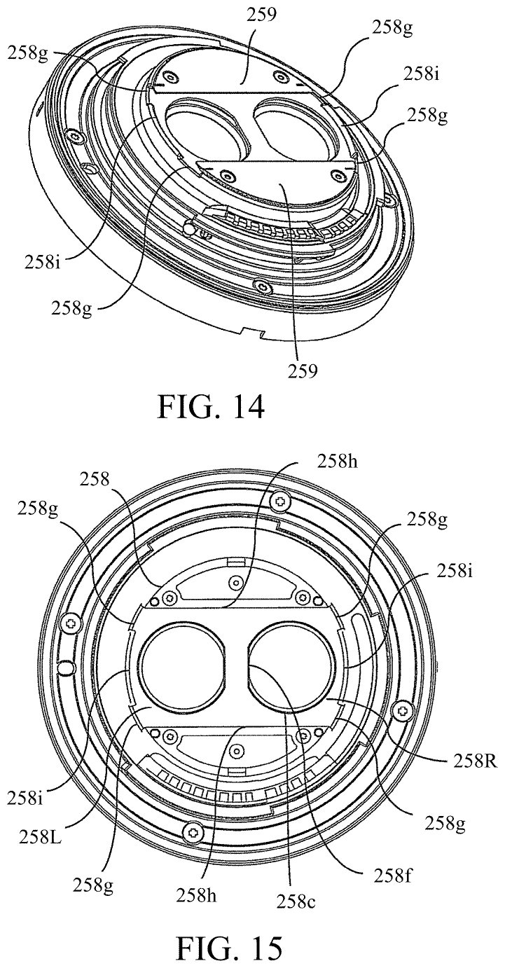

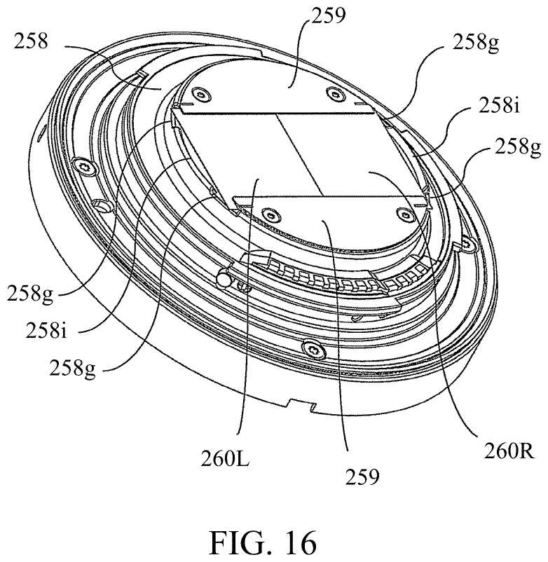

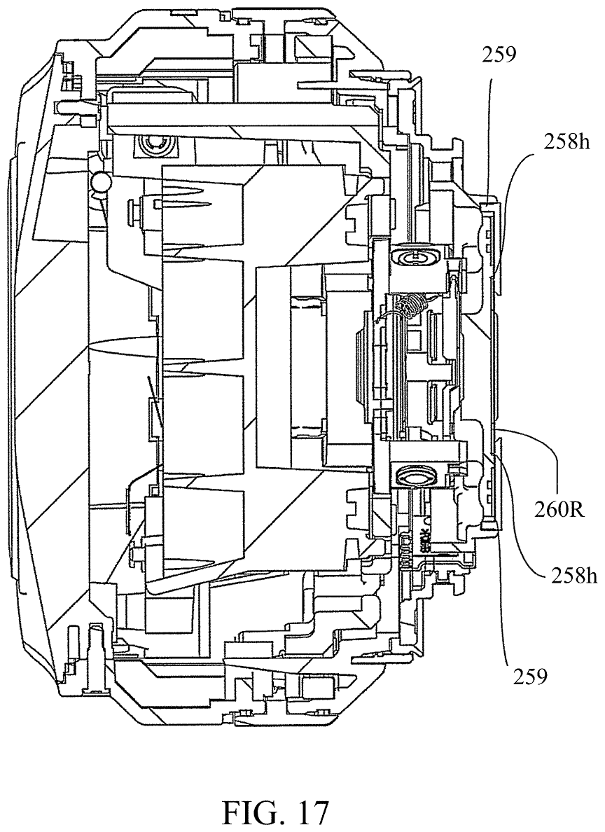

The lens mount 202 will be described below. FIG. 11 is a rear view of a mount cover 258. FIG. 12 illustrates an image circle formed by the circumference fisheye lenses. FIG. 13 is a sectional view of the mount cover 258. FIG. 14 is a perspective view of the mount cover 258. FIG. 15 is a rear view of the mount cover 258 while the filter holder is detached. FIG. 16 is a perspective view of the mount cover 258 while the filter is attached. FIG. 17 is a sectional view taken through a mount center of the mount cover 258 while the filter is attached.

The mount cover 258 includes a first cover portion 258a on the object side of the left and right final lens surfaces, and a second cover portion 258b formed so as to protrude from the left and right lens surfaces and the first cover portion 258a toward the imaging plane side at the center of the first cover portion 258a. Left and right cylindrical wall portions (first wall portion, second wall portion) 258R and 258L in which the openings (first opening, second opening) are formed through which light emitted from the final lens surface passes are formed at positions opposite to the left and right final lens surfaces of the second cover portion 258b. The cylindrical wall portions 258R and 258L are formed so as to surround the outer circumferences of the left and right final lens surfaces on the attachment surface side to the camera body 110. End portions 258c of the cylindrical wall portions 258R and 258L on the imaging plane side are formed in an arc edge shape protruding inward of the opening. The end portions 258c and the cylindrical wall portions 258R and 258L form circles coaxial with the final lenses, and the end portions 258c cut unnecessary light reflected by the cylindrical wall portions 258R and 258L to prevent ghosts. A D-cut portion 258f is provided inside the mount center of each end portion 258c. That is, the opening formed in the second cover portion 258b has an area that is made by cutting an area on the adjacent opening side (area on the adjacent opening side of a predetermined chord that is closer to the adjacent opening than the centerline of the opening) from a circular shape. Here, the circular shape includes not only a perfect circle shape but also a substantial or approximate circle shape. In the case where a catoptric optical system such as a prism is used to bring the optical axes on the imaging plane side closer, the light reflected multiple times in the prism is likely to reach the imaging plane and cause a ghost, in addition to a regular optical path for reflecting only once. The D-cut portion 258f has a role of a light-shielding wall that shields light so as to prevent crosstalk in which the light emitted from one of the left and right final lens surfaces enters the image circle formed on the image sensor 111 due to the light emitted from the other.

This embodiment provides the D-cut portions 258f, which are the light-shielding walls, to parts of the cylindrical wall portions 258R and 258L, but may provide only the light-shielding walls without providing the cylindrical wall portions (that is, without providing the mount cover 258).

When the right-eye optical system 201R and the left-eye optical system 201L are circumferential fisheye lenses, unnecessary light in the entire circumference of each optical system can be cut. As described above, each optical system may be a circumferential fisheye lens or a wide-angle (diagonal) fisheye lens that is not a circumferential fisheye lens.

Since an ultra-wide-angle lens such as the circumferential fisheye lens has a wide angle of view, it is difficult to dispose a filter on the object side of the lens. In this embodiment, the filter is attached to the mount cover 258 side. As illustrated in FIG. 15, a guide portion 258h is a step for guiding the filter. By attaching two filter holders (first holder, second holder) 259, a groove portion DT into which the filter can be inserted is vertically symmetrically formed along the guide portion 258h between the mount cover 258 and each of the two filter holders 259. By inserting the filters into the groove portion DT, the two filter holders 259 can hold the filters. The two filter holders 259 have vertically symmetrical shapes (same shapes) and are disposed on one side and the other side with respect to the openings in a direction orthogonal to the arrangement direction of the openings formed in the mount cover 258.

FIG. 17 illustrates a state in which the filter is inserted in the gap between the guide portion 258h and each of the two filter holders 259. By inserting the filters, the optical effect can be added to captured images.

In FIG. 16, a blue filter 260R is attached to the right-eye side, and a red filter 260L is attached to the left-eye side. Since a filter can be attached from each of the left and right sides, it is possible to attach different filters to the left eye and the right eye and to capture an image for reproducing the conventional 3D image with blue-red glasses.

By incorporating the filters 260 beyond stoppers 258i in inserting them into the groove portion DT, convex portions of the stoppers 258i can prevent the filters from coming off.

In addition, four concave portions 258g, which are one step lower than the surface on which the filters 260 are mounted, are provided at the four corners. Therefore, though the groove portion DT and the stoppers 258i are close to each other, the concave portions 258g have inviting shapes and are connected to guide portions 258h, so that the filters 260 can be easily inserted along the groove portion DT.

Since corner portions of the filters 260 protrude from the concave portions 258g, the filters 260 can be easily detached by pinching the corner portions of the filters 260 with tweezers or the like. It is also possible to attach a single filter that is made by integrating the left and right filters from one of the left and right sides. In this case, since the single filter covers the two, i.e., left and right optical systems, there is no characteristic variations between the left and right filter portions and the number of attachments/detachments of the filter can be advantageously only once. In addition, in this case, one variation may be made to shorten one of the left and right stoppers 258i on the attachment side so as to facilitate the attachment. Alternatively, the stopper on the attachment side may be eliminated.

As illustrated in FIG. 12, since the two optical systems form images on a single image plane, these images are formed upside down and left and right reversed if the image plane is a normal image plane. Since a normally used image is made by rotating the image plane by 180 degrees, an image 300R of the right-eye optical system 201R is formed on the left side of the final image, and an image 300L of the left-eye optical system 201L is formed on the right side of the final image.

However, by arranging two lenses having wide angles of view such as fisheye lenses, the image of the right-eye optical system 201R is formed in the left image circle, and the first lens 211L of the left-eye optical system 201L, the cover member 213 and the exterior portion around it are always imaged in an area A. Similarly, the image of the left-eye optical system 201L is formed in the right image circle, and the first lens 211R of the right-eye optical system 201R, the cover member 213 and the exterior portion around it are always imaged in an area B. Therefore, a complete 360-degree image cannot be formed with only one of the left and right eyes.

An effective light ray of the circumferential fisheye lens is imaged on the image plane without being shielded by the end portions 258c of the cylindrical wall portions 258R and 258L. However, the D-cut portions 258f have convex shapes from the arc portions of the end portions 258c, images are not completely lost in areas 311 and 312 in FIG. 12, but the light ray to be imaged is partially shielded. Hence, so-called vignetting occurs in which the image becomes darker than another peripheral part. The areas 311 and 312 in which the vignetting occurs correspond to the area A of the right-eye optical system and the area B of the left-eye optical system, respectively. When an ultra-wide-angle optical system such as a fisheye lens is used in an interchangeable lens for stereoscopic imaging, a phenomenon occurs in which the lens closest to the object of the adjacent optical system is reflected. In this case, since the object is imaged only by the other optical system in the area where the adjacent lens is reflected, a stereoscopic image cannot be obtained. If a lens or exterior of an adjacent optical system is reflected, stereoscopic viewing is unavailable in that area. There is no practical issue even if vignetting occurs in the image of the other optical system in the corresponding portion.

This embodiment can provide a lens mount and a lens apparatus having the same, each of which can have a simple structure and facilitate attachment and detachment of a filter.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-097794, filed on Jun. 11, 2021, which is hereby incorporated by reference herein in its entirety.

What is claimed is:

1. A lens mount configured to attach and detach a lens apparatus to and from an image pickup apparatus, wherein the lens apparatus includes a first optical system and a second optical system, the lens mount comprising:
a cover member having a first opening corresponding to the first optical system and a second opening corresponding to the second optical system; and
a holder configured to hold at least one filter configured to cover the first opening and the second opening,
wherein the holder includes a first holder disposed on one side with respect to the first and second openings in a direction orthogonal to an arrangement direction of the first and second openings, and a second holder disposed on the other side with respect to the first and second openings in the direction orthogonal to the arrangement direction, and
wherein a groove portion is formed between the cover member and the holder, and the at least one filter is insertable into the groove portion.

2. The lens mount according to claim 1, wherein the first holder and the second holder have the same shape.

3. The lens mount according to claim 1, further comprising:
a first wall portion in which the first opening is formed, wherein the first wall portion includes an end portion projecting inside the first opening and located on an attachment surface side to the image pickup apparatus; and
a second wall portion in which the second opening is formed, wherein the second wall portion includes an end portion projecting inside the second opening and located on the attachment surface side to the image pickup apparatus.

4. The lens mount according to claim 1, wherein the first opening has a shape made by cutting from a circular shape an area on a second opening side of a chord parallel to the direction orthogonal to the arrangement direction, and
wherein the second opening has a shape made by cutting from a circular shape an area on a first opening side of a chord parallel to the direction orthogonal to the arrangement direction.

5. The lens mount according to claim 4, wherein a range shielded by the first opening is a range included in a range in which a lens of the first optical system is reflected in an image of the second optical system, and
wherein a range shielded by the second opening is a range included in a range in which a lens of the second optical system is reflected in an image of the first optical system.

6. A lens apparatus comprising:
a first optical system;
a second optical system; and
a lens mount configured to attach and detach the lens apparatus to and from an image pickup apparatus,
wherein the lens mount includes:
a cover member having a first opening corresponding to the first optical system and a second opening corresponding to the second optical system, and
a holder configured to hold at least one filter configured to cover the first opening and the second opening,
wherein the holder includes a first holder disposed on one side with respect to the first and second openings in a direction orthogonal to an arrangement direction of the first and second openings, and a second holder disposed on the other side with respect to the first and second openings in the direction orthogonal to the arrangement direction, and
wherein a groove portion is formed between the cover member and the holder, and the at least one filter is insertable into the groove portion.
